(19) United States
(12) Patent Application Publication
(10) Pub. No.: US 2008/0109423 A1
(43) Pub. Date: May 8, 2008

(54) APPARATUS AND METHOD FOR DATABASE PARTITION ELIMINATION FOR SAMPLING QUERIES

(76) Inventors: Eric Lawrence Barsness, Pine Island, MN (US); John Matthew Santosuosso, Rochester, MN (US)

Correspondence Address: MARTIN & ASSOCIATES, LLC, P.O. BOX 548, CARTHAGE, MO, 64836-0548, US

(21) Appl. No.: 11/557,562

(22) Filed: Nov. 8, 2006

(51) Int. Cl. G06F 17/30

(52) U.S. Cl. 707/5; 707/E17.014

(57) ABSTRACT

A database query partition elimination mechanism collects historical information when a sampling query is first run against a partitioned database table, then uses the historical information for subsequent executions of the same sampling query to perform partition elimination so the sample query is run on less than all of the partitions. By eliminating one or more of the table's partitions when executing the query, the performance of the query is improved.

### BACKGROUND

1. Technical Field

This disclosure generally relates to the database systems, and more specifically relates to ways for improving the performance of sampling queries over a partitioned database table.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records that satisfy the query are returned as the query result. A popular query language is Structured Query Language (SQL), which has gained widespread acceptance in the database industry.

Modern databases recognize that exact data need not always be returned for some queries. This realization led to the development of techniques for sampling a table for queries that need only approximate results. For example, if a query is run against a table with a million rows to determine the average of some column in the table, the query will take considerable time due to the large size of the table. Sampling may be used to sample some small percentage of the table and return a result based on the smaller sample. The result is a query result that may be slightly less accurate, but that can be performed orders of magnitude faster. This tradeoff between slightly less accuracy and significantly greater performance is a good one when the accuracy of the query result is not critical. For example, a user might formulate a query to calculate the average age of students in a particular university. Let's assume executing the query against the full table produces an average age of 20.32 years. Let's further assume that executing the query against 0.1% of the rows in the table produces an average age of 20.36 years. If the purpose of the query is to determine whether the average age is closest to 20 or 21, the sampling query produces acceptable results at a significantly greater performance.

Database tables may be partitioned for a variety of different reasons. Running a sampling query on a partitioned database causes the query to be executed on each partition, but only a specified percentage of the rows in each partition is sampled. The benefit of the sampling is offset somewhat by the cost of running the partition on all of the partitions. Without a way to reduce the overhead of executing a sampling query to a partitioned database table, the database industry will continue to pay the performance penalty of always executing a sampling query against all partitions in a partitioned database table.

### BRIEF SUMMARY

A database query partition elimination mechanism collects historical information when a sampling query is first run against a partitioned database table, then uses the historical information for subsequent executions of the same sampling query to perform partition elimination so the sample query is run on less than all of the partitions. By eliminating one or more of the table's partitions when executing the query, the performance of the query is improved.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that includes a sampling query partition elimination mechanism for automatically eliminating one or more partitions, when possible, during the execution of a sampling query against a partitioned database table;

FIG. 2 is a flow diagram of a prior art method for performing partition elimination based on query predicates;

FIG. 3 is a sample query for illustrating the prior art partition elimination described in method 200 in FIG. 2;

FIG. 4 is a sample partitioned database table for the query in FIG. 3;

FIG. 5 is an example of a query that performs a full table scan;

FIG. 6 is an example of a query similar to the query in FIG. 5 that performs one percent sampling of the table;

FIG. 7 is a flow diagram of a method for performing partition elimination during the processing of a sampling query to a partitioned database table;

FIG. 8 is an example of a sampling query;

FIG. 9 is an example of historical information and a variance specification for the partitioned table referenced in the query in FIG. 8;

FIG. 10 shows the elimination of partition 1 and running the query against partition 2 for the example in FIGS. 8 and 9;

FIG. 11 is another example of a sampling query;

FIG. 12 is an example of historical information and a variance specification for the partitioned table referenced in the query in FIG. 11; and

FIG. 13 shows the elimination of partitions 1 and 3 and running the query against partitions 2 and 4 for the example in FIGS. 11 and 12.

### DETAILED DESCRIPTION

### 1.0 Overview

The present invention relates to improving performance of sampling database queries to partitioned database tables. For those not familiar with databases, queries, or partitioned database tables, this Overview section will provide background information that will help to understand the present invention.

### Known Databases and Database Queries

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. A database query is an expression that is evaluated by a database manager. The expression may contain one or more predicate expressions that are used to retrieve data from a database. For example, lets assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

One popular way to define a query uses Structured Query Language (SQL). SQL defines a syntax for generating and processing queries that is independent of the actual structure and format of the database. SQL has become very popular in the database field for performing queries on databases.

### Known Partitioned Database Tables

A partitioned database table is divided into multiple discrete portions referred to as partitions. Each entry in the table is allocated to a respective one of the partitions. A partition is usually a discrete data entry, such as a file, but contains the same definitional structure as all other partitions of the same table. Partitioning may be performed for a variety of reasons, and is usually performed on very large tables as a way to break the data into subsets of some conveniently workable size. By dividing a table into partitions, improved execution efficiency can result by working with a smaller subset of the table instead of the whole table.

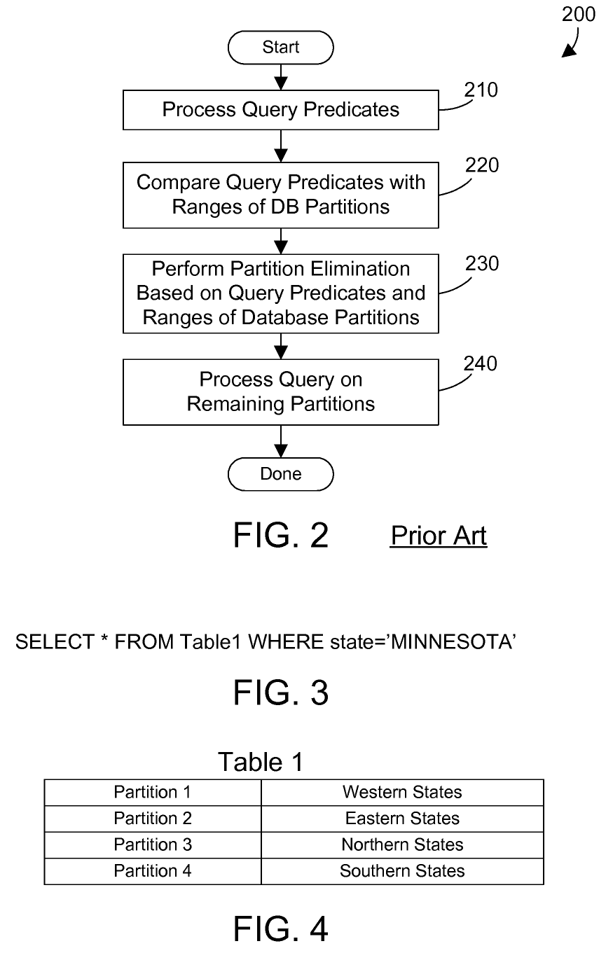

Partition elimination for a partitioned database query based on predicate analysis is known. A sample prior art method 200 is shown in FIG. 2. The query predicates are processed (step 210). The query predicates are then compared with the ranges that define the database partitions (step 220). Partition elimination is then performed, if possible, based on the query predicates and the ranges of the database partitions (step 230). After partition elimination in step 230, the query is processed on the remaining partitions (step 240).

A simple example is now given to illustrate the prior art method 200 shown in FIG. 2. The query in FIG. 3 selects all records from Table 1 where the state field specifies “Minnesota.” We assume for this example that Table 1 is partitioned into four partitions according to the location of the state as shown in FIG. 4. Thus, Western States are in Partition 1, Eastern States are in Partition 2, Northern States are in Partition 3, and Southern States are in Partition 4.

The steps in method 200 are now performed with respect to the example query in FIG. 3 and partitioned Table 1 in FIG. 4. First, the query predicates are processed (step 210). The processing of the query predicate WHERE state=‘MINNESOTA’ in the query in FIG. 3 specifies a value of MINNESOTA for the state column. Next, the query predicates are compared with the ranges of the database partitions (step 220). Thus, the value of Minnesota is compared against the ranges of the defined partitions in FIG. 4. We assume Minnesota is in Partition 3 that includes the Northern states. As a result, we know that the query in FIG. 3 need only be executed on Partition 3, so Partitions 1, 2 and 4 can be eliminated when processing the query in FIG. 3. This type of partition elimination based on query predicates illustrated in FIGS. 2-4 is known in the art.

### 2.0 Detailed Description

A sampling query partition elimination mechanism collects historical information the first time a sampling query is run against a partitioned database table, then uses the historical information during subsequent executions of the sampling query to eliminate one or more partitions during the execution of the query. An aggregate sampling variance is used to determine whether a partition may be eliminated. If the partition does not satisfy the aggregate sampling variance, the partition is not eliminated. By eliminating one or more partitions during the execution of a sampling query to a partitioned database table, the time required to execute the query is reduced.

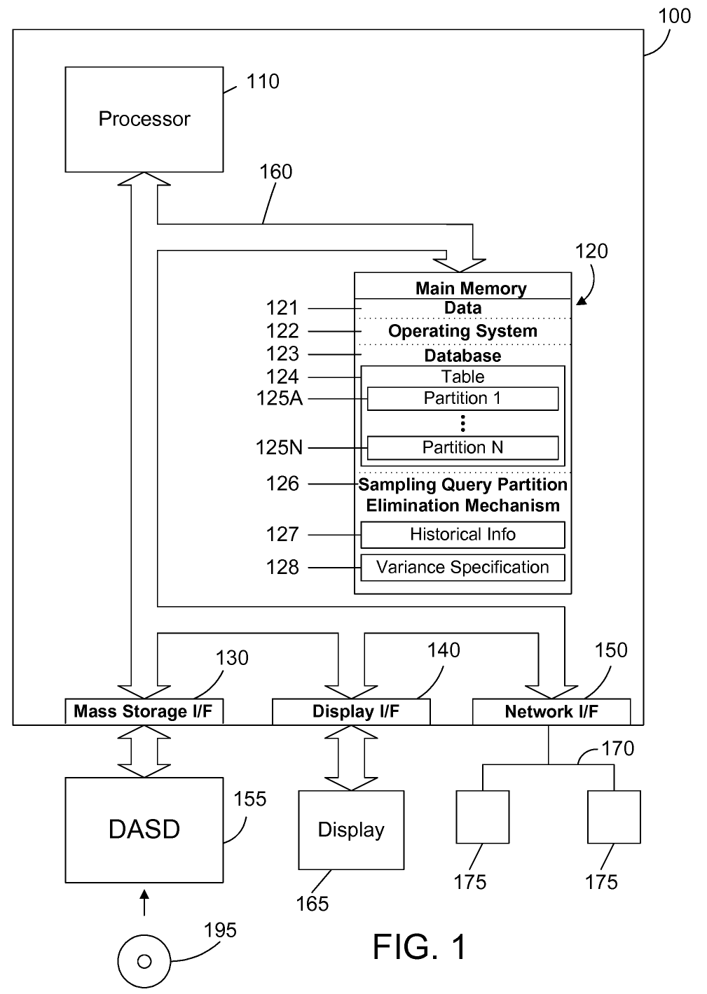

Referring to FIG. 1, a computer system 100 is one suitable implementation of an apparatus that includes a sampling query partition elimination mechanism for automatically eliminating one or more partitions, when possible, during the execution of a sampling query against a partitioned database table. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, a database 123 that includes a table 124 that has multiple partitions, shown in FIG. 1 as partitions 125A, . . . , 125N, and a sampling query partition elimination mechanism 126. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Database 123 is any suitable database that supports partitioned tables, whether currently known or developed in the future. Partitions 125A, . . . , 125N are shown in FIG. 1 to reside in the same memory 120, but one skilled in the art will recognize that partitions of a partitioned database table often reside on completely separate computer systems coupled together via a network. While the partitions in table 124 are shown residing in the same memory 120 on the same computer system 100, this is shown in this manner for the sake of convenience, and the disclosure and claims herein expressly extend to partitioned tables that have partitions residing on different computer systems.

Sampling query partition elimination mechanism 126 processes a sampling query to the partitioned database table 124 to determine whether the query may be executed on less than all of its partitions. As stated in the Background Art section above, many queries do not require exact answers, approximations work just fine. For these types of queries, eliminating one or more partitions results in improved performance of sampling queries to a partitioned database table. The sampling query partition elimination mechanism 126 functions according to historical information 127 gathered from previous executions of the same query and according to a variance specification 128. The historical information 127 preferably includes the result returned from executing the query on each partition along with the time required to execute the query on each partition. The variance specification 128 specifies how much an individual partition's results may vary from the overall query result. If a partition satisfies the aggregate sample variance 128, it may be potentially eliminated from being processed in executing the sampling query, while those that do not satisfy the variance specification 128 are not eligible to be eliminated.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, and sampling query partition elimination mechanism 126 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that partition elimination for sampling queries to a partitioned database table may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. Network interface 150 and network 170 broadly represent any suitable way to interconnect computer systems, regardless of whether the network 170 comprises present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the description above is in the context of a fully functional computer system, those skilled in the art will appreciate that the sampling query partition elimination mechanism may be distributed as a program product in a variety of forms, and that the claims extend to all suitable types of computer-readable media used to actually carry out the distribution. Examples of suitable computer-readable media include: recordable media such as floppy disks and CD-RW (e.g., 195 of FIG. 1), and transmission media such as digital and analog communications links.

Embodiments herein may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

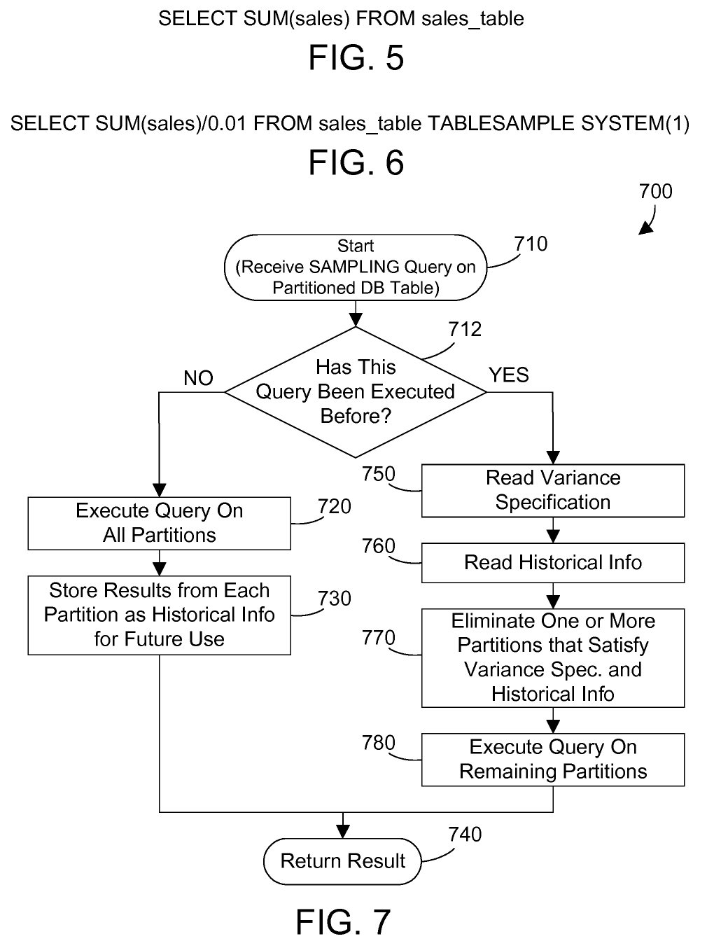

Referring to FIG. 5, a query “SELECT SUM(sales) FROM sales_table” is a query that is executed by performing a table scan of each and every row of sales_table. Let's assume that sales_table includes millions of rows. Running the query in FIG. 5 can take a very long time due to the large number of rows in sales_table. The speed of the query can be significantly increased by using a sampling query as discussed in the Background Art section above. A sampling query samples a specified percentage of the rows to approximate the results. If approximate results are acceptable, the sampling query can provide these results much faster, thereby increasing system performance. FIG. 6 shows the query in FIG. 5 rewritten to be a sampling query. At the end of the query the parameters TABLESAMPLE and SYSTEM(1) are specified. The TABLESAMPLE is the operator that specifies this is a sampling query. The SYSTEM parameter specifies what kind of sampling is to be performed. BERNOUILLI sampling may be specified, or SYSTEM may be specified to allow the system to select the appropriate sampling scheme. Of course, other sampling schemes will be developed in the future, and the disclosure and claims herein expressly extend to any suitable sampling query regardless of the sampling scheme used. The number following the SYSTEM parameter specifies what percentage of records to sample in the table. Thus, SYSTEM(1) as specified in FIG. 5 specifies that one percent of the rows in the table will be sampled. Because only one percent of the rows in the table are sampled, the sum of the sample will only be one one-hundredth of the sum of all the rows. As a result, the sum is divided by 0.01 as shown in FIG. 6 to provide an approximation of the total sum of all the rows using one percent sampling.

Referring to FIG. 7, a method 700 begins when a sampling query on a partitioned database table is received for execution (step 710). If this query has not been executed before (step 712=NO), the query is executed on all partitions (step 720). The results from executing the query on all partitions is stored as historical information for future use (step 730), and the result of the query is returned (step 740). If the query has been executed before (step 712=YES), a variance specification is read (step 750). The variance specification determines how much a partition query result may vary from the full query result and still be eliminated. The historical information for one or more past executions of the query is read (step 760). The historical information is the compared with the variance specification to determine whether one or more of the partitions may be eliminated in executing the query. If so, one or more of the partitions are eliminated (step 770). The query is then executed on the remaining partitions (step 780), and the result is returned (step 740). Note that method 700 in FIG. 7 is preferably performed by the sampling query partition elimination mechanism 126 in FIG. 1.

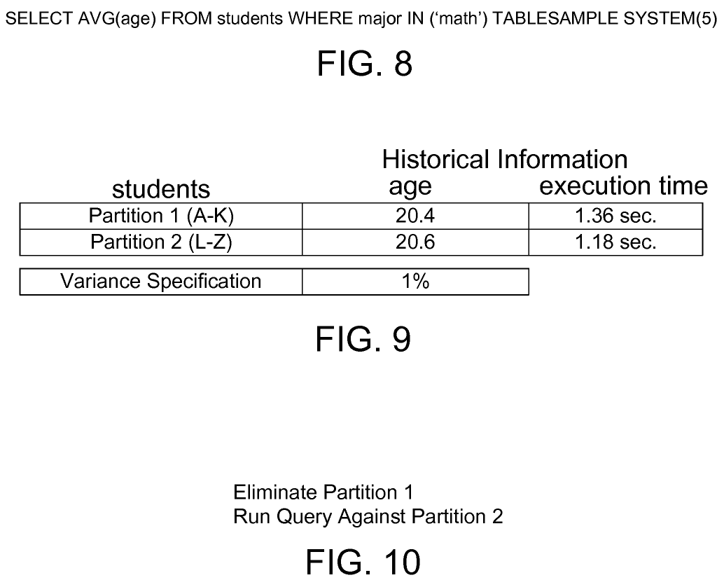

Examples are now presented to illustrate partition elimination for a sampling query to a partitioned database table. FIG. 8 shows a sampling query that uses a five percent sample (SYSTEM(5)) to compute the average age of students in a university that are math majors. We assume for this example the database table “students” is split into two partitions according to the first letter of the student's last name. We further assume the query in FIG. 8 was run the first time on both partitions, with the resulting average ages shown in FIG. 9 of 20.4 years for Partition 1 and 20.6 years for Partition 2. We also assume a variance specification of 1%, which means a partition that varies less than 1% from the overall query result when run on all partitions may be eliminated. Assuming the two partitions have the same number of rows, the average age returned from running the query in FIG. 8 on both partitions is 20.5. Both 20.4 and 20.6 are within the 1% variance specification, so either of these partitions could be eliminated. As shown by the historical information in FIG. 9, we assume the processing of the query on Partition 1 took 1.36 seconds, and the processing of the query on Partition 2 took 1.18 seconds. Because the query took longer to execute on Partition 1, Partition 1 is eliminated from the query, and the query is then run against Partition 2, as shown in FIG. 10. The elimination of Partition 1 reduces the time required to execute the query, thereby improving performance of the sampling query.

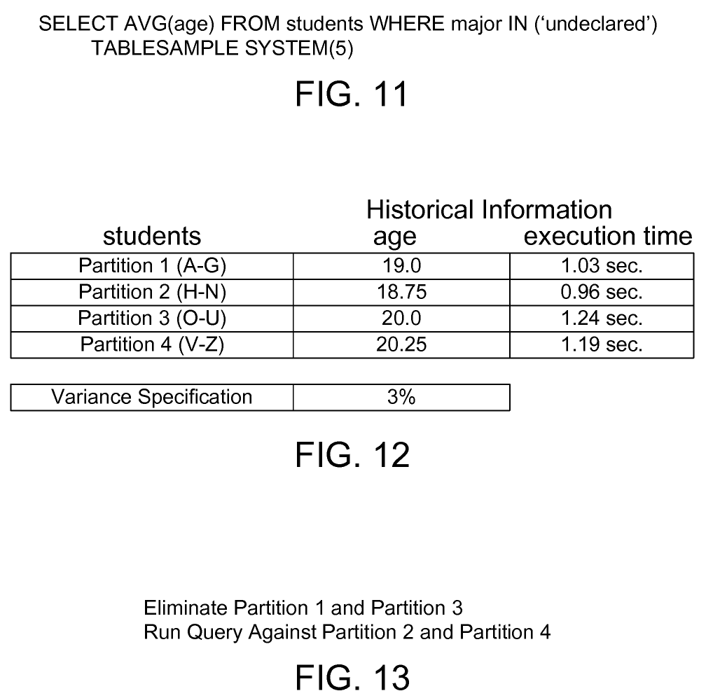

Another example query is shown in FIG. 11, which uses five percent sampling to determine the average age of students that have an undeclared major. We assume for this example the students table has four partitions according to the first letter of the student's last name, as shown in FIG. 12, with each partition including an equal number of rows. The historical information for this query is shown in FIG. 12 to include the average age for each partition and the time to execute the query in each partition. Note the overall average for all partitions is 19.5, and the variance specification is 3%. Three percent of 19.5 is 0.585, so the acceptable range of ages for partitions that may be eliminated is those with an average age in the range of 18.915 to 20.085. We see from the results in the historical information in FIG. 12 that Partition 2 and Partition 4 have results outside this range, and therefore cannot be eliminated. Partitions 1 and 3 have results inside this range, and can therefore be eliminated. As a result, Partitions 1 and 3 are eliminated, and the query is run against Partitions 2 and 4, as shown in FIG. 13.

The variance specification 128 is preferably defined by a user. However, the variance specification 128 could also be computed or derived by the database system according to any suitable criteria or heuristic.

The historical information 127 is preferably updated each time the query is run. However, any suitable method for updating the historical information 127 may be used, including updating the historical information 127 so the information for the current query overwrites the historical information 127, overwriting the historical information 127 every Nth time the query is executed, averaging the historical information 127 to reflect an average of all executions of the query, etc.

The elimination of one or more partitions from a sampling query that is executed on a partitioned database tale improves performance of the query. Because the query may be executed on less than all of the partitions, the time required to execute the query is reduced.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. An apparatus comprising:
at least one processor;
a memory coupled to the at least one processor;
a database residing in the memory;
a partitioned database table in the database; and
a sampling query partition elimination mechanism that processes a sampling query to the partitioned database table and uses historical information from at least one past execution of the sampling query to eliminate at least one partition in the partitioned database table before executing the query on at least one remaining partition in the partitioned database table.

2. The apparatus of claim 1 further comprising a variance specification,
wherein the sampling query partition elimination mechanism eliminates a selected partition in the partitioned database table if the historical information for the selected partition satisfies the variance specification.

3. The apparatus of claim 2 wherein the variance specification is specified by a user.

4. The apparatus of claim 1 wherein the sampling query partition elimination mechanism collects the historical information the first time the sampling query is executed by executing the sampling query on all partitions of the partitioned database table.

5. The apparatus of claim 1 wherein the sampling query partition elimination mechanism updates the historical information each time the sampling query is executed.

6. The apparatus of claim 1 wherein the memory comprises memory in a plurality of computer systems.

7. A networked computer system comprising:
a first computer system that includes a first partition of a partitioned database table;
a second computer system coupled to the first computer system, the second computer system comprising:
a second partition of the partitioned database table; and
a sampling query partition elimination mechanism that processes a sampling query to the partitioned database table and uses historical information from at least one past execution of the sampling query to eliminate at least one of the first and second partitions before executing the query on at least one remaining partition in the partitioned database table.

8. The networked computer system of claim 7 further comprising a variance specification, wherein the sampling query partition elimination mechanism eliminates a selected partition in the partitioned database table if the historical information for the selected partition satisfies the variance specification.

9. The networked computer system of claim 8 wherein the variance specification is specified by a user.

10. The networked computer system of claim 7 wherein the sampling query partition elimination mechanism collects the historical information the first time the sampling query is executed by executing the sampling query on all partitions of the partitioned database table.

11. The networked computer system of claim 7 wherein the sampling query partition elimination mechanism updates the historical information each time the sampling query is executed.

12. A method for executing a sampling query on a partitioned database table, the method comprising the steps of:
if the query has not been executed before, executing the query on all partitions of the partitioned database table and compiling historical information for the query for each partition; and
if the query has been executed before, using the historical information to eliminate at least one partition in the partitioned database table before executing the query on at least one remaining partition in the partitioned database table.

13. The method of claim 12 further comprising the steps of:
reading a variance specification; and
eliminating a selected partition in the partitioned database table if the historical information for the selected partition satisfies the variance specification.

14. The method of claim 13 wherein the variance specification is specified by a user.

15. The method of claim 12 further comprising the step of updating the historical information each time the sampling query is executed.

16. A method for deploying computing infrastructure, comprising integrating computer readable code into a computing system, wherein the code in combination with the computing system perform the method of claim 12.

17. A computer-readable program product comprising:
a sampling query partition elimination mechanism that processes a sampling query to a partitioned database table and uses historical information from at least one past execution of the sampling query to eliminate at least one partition in the partitioned database table before executing the query on at least one remaining partition in the partitioned database table; and
recordable media bearing the sampling query partition elimination mechanism.

18. The program product of claim 17 further comprising a variance specification, wherein the sampling query partition elimination mechanism eliminates a selected partition in the partitioned database table if the historical information for the selected partition satisfies the variance specification.

19. The program product of claim 18 wherein the variance specification is specified by a user.

20. The program product of claim 17 wherein the sampling query partition elimination mechanism collects the historical information the first time the sampling query is executed by executing the sampling query on all partitions of the partitioned database table.

21. The program product of claim 17 wherein the sampling query partition elimination mechanism updates the historical information each time the sampling query is executed.
